(19) United States
(12) Patent Application Publication
(10) Pub. No.: US 2009/0179343 A1
(43) Pub. Date: Jul. 16, 2009

(54) Method for forming a surface layer on a substrate

(76) Inventor: Tzu-Wen Soong, Taipei (TW)

Correspondence Address: BACON & THOMAS, PLLC, 625 SLATERS LANE, FOURTH FLOOR, ALEXANDRIA, VA, 22314-1176, US

(21) Appl. No.: 12/007,620

(22) Filed: Jan. 14, 2008

(51) Int. Cl. B29C 41/22; B29C 70/00; B29C 59/00; B29C 45/14

(52) U.S. Cl. 264/162; 264/255; 264/254; 164/94

(57) ABSTRACT

A method for forming a surface layer on a substrate is provided. First, a mold having a cavity is provided. Next, a surface layer is formed on at least a part of the surface of the mold within the cavity. After that, a molding step is performed.

### FIELD OF THE INVENTION

The present invention relates to a method for forming a surface layer on a substrate, especially a method of forming a surface layer on a plastic, fiber-reinforced composite or metallic housing.

### BACKGROUND OF THE INVENTION

It gets more and more important for people to rely on electronic products in information era. In order to fulfill the requirements of high performance and portability from these products, it makes notebook PC, cell phone, personal digital assistant (PDA) and MP3 player become essential tools for modem people in daily life. Furthermore, for the reason of fashion trend or electromagnetic interference reduction, most of the products contain a metallic housing or a plastic housing with metallic surfaces.

For metallic housings, die casting and injection molding are well known methods for manufacturing. Aluminum-magnesium alloy is wildly used. However, during the process of die casting or injection molding, there are pores easily formed on the surface of the aluminum-magnesium alloy. Besides, it needs extra work to perform anodization or other surface treatments on the metal surfaces in case corrosion occurs when metallic housing contacts with the air. All the problems increase manufacturing processes and costs. A method for evacuating air from a cavity during die casting is described in U.S. Pat. No. 6,176,294 to improve the problem of pores. Another method in U.S. Pat. No. 6,322,689 provides an improved way of anodization. However, these inventions still need lots work done and are not economic in time and cost.

On the other hand, for a plastic housing with metallic surface, it is usually produced by injection molding together with thermal spray. More specifically, it uses injection molding to shape the plastic housing and thermal spray to form the metallic layer on the surface. However, because the temperature of the environment is very high when thermal spray is carried out, it often causes problems, such as deformation or burning of the plastic housing. A high temperature thermal sprayable material is provided in U.S. Pat. No. 5,718,970 against the problem.

Besides, sputtering can replace thermal spray for forming a metallic surface. However, the processes of sputtering are not only complicated but also hard to increase the thickness of the metallic surface. The yield rate is difficult to make great strikes.

As to other housings made of fiber-reinforced composite, such as glass fiber, carbon fiber, Kevlar fiber, ceramic fiber and metal fiber, they have similar or same situations as plastic housings.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph is also considered to refer.

In view of the problems mentioned above, the goal of this invention is to provide a method for forming a surface layer on a substrate. The method can be applied to a housing made of plastics, fiber-reinforced composites or metals, further avoiding deforming and burning the plastic and fiber-reinforced housing and solving problems of pores on a metallic surface.

In accordance with an aspect of the present invention, the method for forming a surface layer on a substrate includes the steps of providing a mold with a cavity, forming a surface layer at least on one part of the mold within the cavity, and molding a substrate.

Preferably, the surface layer comprises metallic or ceramic materials.

Preferably, the forming step uses thermal spray.

Preferably, the forming step uses a preformed surface material placed at least on a part of the mold within the cavity.

Preferably, the mold has an upper mold and a lower mold.

Preferably, the surface layer is formed on an inner surface of the upper mold or lower mold within the cavity.

Preferably, the surface layer is formed on inner surfaces of the upper mold and lower mold within the cavity.

Preferably, the method applies a mold release agent on an inner surface of the mold before the surface layer is formed.

Preferably, the molding is injection molding.

Preferably, the injection molding uses a plastic material, fiber-reinforced composite or metallic material.

Preferably, the molding is metal casting.

Preferably, the metal casting uses a metallic material.

Preferably, the molding is die casting.

Preferably, the die casting uses a metallic material.

Preferably, the metallic material comprises an aluminum-magnesium alloy, a titanium alloy, an aluminum alloy, a magnesium alloy, a zirconium alloy or a zinc alloy.

Since the invention provides the surface layer formed in the surface of the mold within the cavity before molding the plastic, fiber-reinforced composite or metallic housing, the surface layer can be smooth. Besides, if the housing is metallic, the coming processes have no affection on the surface layer and the pores on the surface layer will be decreased since the surface layer is preformed. If a plastic housing is used, since the surface layer is formed before the housing, the invention avoids deforming and burning the housing due to the high temperature of environment when thermal spray is used. It also solves the problem of increasing the thickness of surface layer caused by sputtering.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a schematic diagram of a mold with a cavity and an opening according to the present invention;

FIG. 2 illustrates a schematic diagram of a surface layer on a surface of the mold within the cavity according to the present invention;

FIG. 3 illustrates a schematic diagram of a molding process according to the present invention; and

FIG. 4 illustrates a schematic diagram of a surface layer on a substrate after removing the mold according to the present invention.

### DETAILED DESCRIPTION OF THE PREFERRED EMBODIMENT

The present invention will now be described more specifically with reference to the following embodiment. It is to be noted that the following description of preferred embodiment of this invention is presented herein for purpose of illustration and description only. It is not intended to be exhaustive or to be limited to the precise form disclosed.

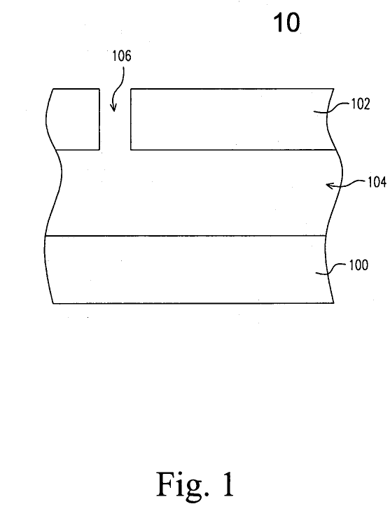

With reference to FIG. 1, this embodiment provides a mold 10 with a lower mold 100, an upper mold 102 and at least one opening 106 (in this embodiment, only one is shown). When the lower mold 100 and the upper mold 102 couple together, the space inside the mold 10 forms a cavity 104. Through the opening 106 in the upper mold 102, a plastic, fiber-reinforced composite or metallic material can be filled into the cavity 104 and a final product with same shape as the cavity 104 will be formed.

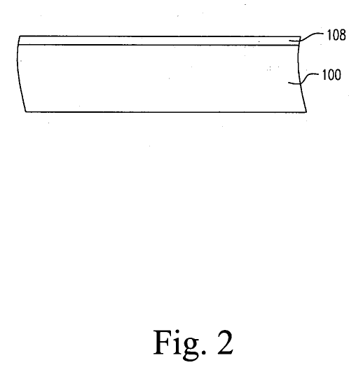

In FIG. 2, it illustrates a surface layer 108 formed at least on one part of the mold 10 within the cavity 104. In this embodiment, the surface layer 108 is formed on the whole surface of lower mold 100 within the cavity 104. In detail, thermal spray can be used to form the surface layer 108 on the surface of the lower mold 100 within the cavity 104 before the lower mold 100 and the upper mold 104 are coupled. The surface layer 108 can be made of metals or ceramics (e.g., bone china, aluminum oxide, zirconium dioxide, titanium dioxide, etc.). Particularly, the surface layer 108 can be formed on a part of the surface of the lower mold 100 within the cavity 104 in order to shape any pattern needed to be shown on a plastic, fiber-reinforced composite or metallic housing in coming processes. Of course, the surface layer 108 can be formed on a part of the surface of the upper mold 102 within cavity 104 as well. It also works to form the surface layer 108 on the whole or part of the lower mold 100 and the upper mold 102 within the cavity 104. In addiction to the thermal spray, an alternative can prepare a preformed material of the surface layer 108 and place it on at least one part of the mold 10 within the cavity 104.

It is worthy to mention that since the surfaces of the lower mold 100 and the upper mold 102 forming the cavity 104 are extremely smooth, the surface layer 108 can be easily apart from the mold 10. Besides, to ensure the surface layer 108 to be completely separated from the mold 10, it is optional to use a mold release agent (not shown) on the surfaces of the lower mold 100 and the upper mold 102 forming the cavity 104 before the surface layer 108 is formed.

Furthermore, in order to have other functions (e.g. embedded antenna, bulletproof ability, anti-radiation, anti-EMI, etc.) for the housing (made of plastic, fiber-reinforced composite or metallic materials) formed later, other attaching objects, such as antenna, bulletproof piece, etc., are optionally attached on the surface layer 108 after the surface layer 108 is formed. Of course, the process of attaching mentioned above can be performed before the materials of the surface layer 108 are placed at least on one part of surfaces of lower mold 100 and the upper mold 102 within the cavity 104.

Moreover, for stronger adhesion between the substrate 112 (plastic, fiber-reinforced composite or metallic) and the surface layer 108 or the attaching objects, it is optional to roughen the surface layer 108 or the surface of the attaching objects. The process of roughening mentioned above can be performed before the materials of the surface layer 108 or the attaching objects are placed on at least one part of surfaces of lower mold 100 and the upper mold 102 within the cavity 104.

In addition, it is optional to trim the edge of the surface layer 108 or the attaching object in order to make the contour as desired after the surface layer 108 is formed. The process of trimming mentioned above can be performed before the materials of the surface layer 108 or the attaching objects are placed on at least one part of surfaces of lower mold 100 and the upper mold 102 within the cavity 104.

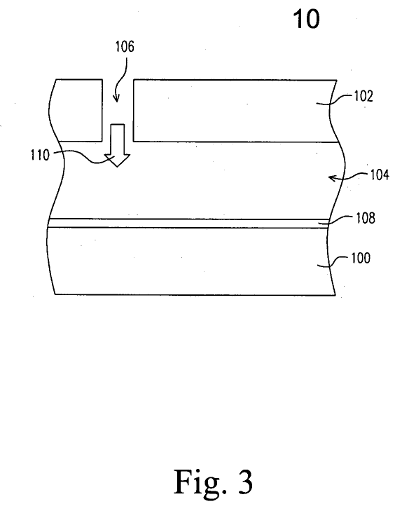

Next, with reference to FIG. 3, the molding proceeds. In this embodiment, the molding process, such as injection molding or metal casting, fills a molding material 110 into the cavity 104 in the mold 10. The molding materials 110 used for injection molding is plastic, fiber-reinforced or metallic. Metal casting uses metallic molding materials. Particularly, the process of molding can be die casting. Die casting uses metallic molding materials. The metallic molding materials comprise an aluminum-magnesium alloy, a titanium alloy, an aluminum alloy, a magnesium alloy, a zirconium alloy or a zinc alloy.

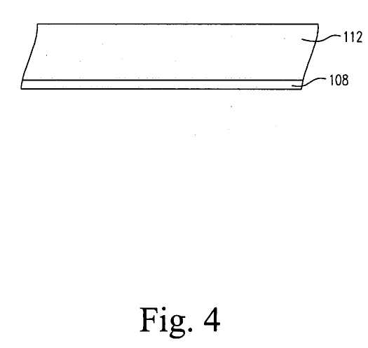

After the processes are completed, the mold 10 can be taken apart and removed. FIG. 4 illustrates the surface layer 108 formed on a substrate 112 after the lower mold 100 and the upper mold 102 are removed. Because process of forming the substrate 112 is proceeded after the surface layer 108 is ready, it avoids deformation of the substrate 112 made of plastic or fiber-reinforced molding material caused by the high temperature of environment when the surface layer 108 in forming.

Alternatively, a mold consisting of a front mold and a rear mold depending on the requirements of the final product can be used. The number of individual molds is not limited to 2. An opening can be provided as in this embodiment.

In summary, the invention provides a surface layer on an inner surface of a mold within a cavity before molding process, so pores on the surface layer will be decreased in the coming processes because the surface layer exists already.

Besides, if a housing uses a plastic or fiber-reinforced molding material, since the surface layer is formed before the housing, the invention avoids deforming and burning the housing due to the high temperature of environment when thermal spray is used. It solves the difficulties to increase the thickness of surface layer caused by sputtering.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are accorded with the broadest interpretation so as to encompass all such modifications and similar structures.

What is claimed is:

1. A method for forming a surface layer on a substrate, comprising the steps of:
providing a mold having a cavity therein;
forming a surface layer at least on a part of the mold within the cavity; and
molding the substrate.

2. The method according to claim 1, wherein the surface layer comprises metallic or ceramic materials.

3. The method according to claim 1, wherein the forming step uses thermal spray.

4. The method according to claim 1, wherein the forming step uses a preformed surface material placed on the part of the mold within the cavity.

5. The method according to claim 1, wherein the mold has a number of molding parts including an upper mold and a lower mold, and at least one through opening.

6. The method according to claim 5, wherein the number is not less than two.

7. The method according to claim 5, wherein the surface layer is formed on an inner surface of the upper mold or lower mold within the cavity.

8. The method according to claim 5, wherein the surface layer is formed on inner surfaces of the upper mold and lower mold within the cavity.

9. The method according to claim 1, further comprising applying a mold release agent on an inner surface of the mold within the cavity before the forming step.

10. The method according to claim 1, further comprising attaching an appendants on an inner surface of the mold within the cavity after the forming step.

11. The method according to claim 10, wherein the appendants are antennas, lead pellets or bulletproof pieces.

12. The method according to claim 1, further comprising roughening the surface layer after the forming step.

13. The method according to claim 10, further comprising roughening the surface layer with the appendants after the attaching step.

14. The method according to claim 1, further comprising trimming the surface layer after the forming step.

15. The method according to claim 10, further comprising trimming the surface layer with appendants after the attaching step.

16. The method according to claim 1, wherein the molding is injection molding.

17. The method according to claim 16, wherein the injection molding uses a plastic, fiber-reinforced composite or metallic material.

18. The method according to claim 1, wherein the molding is metal casting.

19. The method according to claim 18, wherein the metal casting uses a metallic material.

20. The method according to claim 1, wherein the molding is die casting.

21. The method according to claim 20, wherein the die casting uses a metallic material.

22. The method according to claim 17, 19 or 21, wherein the metallic material comprises an aluminum-magnesium alloy, a titanium alloy, an aluminum alloy, a magnesium alloy, a zirconium alloy or a zinc alloy.
